(19) United States
(12) Patent Application Publication
(10) Pub. No.: US 2013/0016240 A1
(43) Pub. Date: Jan. 17, 2013

(54) IMAGE PROCESSING APPARATUS, IMAGE PROCESSING METHOD, AND STORAGE MEDIUM

(71) Applicants: Masaaki Sasaki, Tokyo (JP); Kazuya Nara, Tokyo (JP)

(72) Inventors: Masaaki Sasaki, Tokyo (JP); Kazuya Nara, Tokyo (JP)

(73) Assignee: CASIO COMPUTER CO., LTD., Tokyo (JP)

(21) Appl. No.: 13/546,419

(22) Filed: Jul. 11, 2012

(30) Foreign Application Priority Data
Jul. 15, 2011 (JP) 2011-157186

(51) Int. Cl. H04N 5/228

(52) U.S. Cl. 348/208.4; 348/E05.031

(57) ABSTRACT

An image processing apparatus includes an at-rest-state determination unit that determines whether the image processing apparatus is at rest or not based on motion vectors of image data, and an image change detecting unit that detects the change in image data sequentially inputted. Then, in a state in which it is determined by a determination unit that an image processing apparatus is at rest, an image change detecting unit detects a change in image data, and in a case in which the image data has changed, records the data of the captured image.

This application is based on and claims the benefit of priority from Japanese Patent Application No. 2011-157186, filed on 15 Jul. 2011, the content of which is incorporated herein by reference.

### BACKGROUND OF THE INVENTION

1. Field of the Invention

The present invention relates to an image processing apparatus, an image processing method, and a storage medium.

2. Related Art

In recent years, a technology has emerged for performing recording automatically with an image processing apparatus such as a digital camera, by recognizing an object included in a captured image, and then using a recognition result thereof.

For example, in the imaging apparatus disclosed in Japanese Unexamined Patent Application, Publication No. 2008-098891, in a case in which a plurality of moving objects is recognized. within an image, a moving area size (number of blocks) and a moving area time difference (change in the number of blocks) are obtained for each block (hereinafter, referred to as “a moving area”) containing the moving objects.

Then, in a case in which the obtained moving area size and the moving area time difference satisfy set conditions, the moving area is set for automatic exposure processing and automatic focusing processing.

However, in the case of the above technology, since the influence of a change in the field angle due to camera shake or the like is not taken into consideration in the recognition results, there is a possibility for error to arise in the determination for the presence of a moving area, and thus there has been concern over automatic recording processing not being carried out properly.

### SUMMARY OF THE INVENTION

The present invention addresses such a situation, and has an object of improving control of the recording image data performed using image recognition of a captured image.

In order to achieve the above object, an image processing apparatus according to an aspect of the present invention includes:

an imaging unit;

an acquisition unit that sequentially obtains image data captured by the imaging unit;

a determination unit that determines whether the imaging unit is at rest;

a detecting unit that detects a change in the image data thus sequentially obtained, in a state in which the determination unit determined that the imaging unit is at rest; and

an image data recording unit that records an image data thus obtained, responcing a change in the image data thus sequentially obtained is detected by the detecting unit.

In addition, in order to achieve the above object, an image processing method for an image processing apparatus having an imaging unit, includes: a step of sequentially obtaining image data captured by the imaging unit; a step determining whether the imaging unit is at rest; a step of detecting a change in the image data thus sequentially obtained, in a state in which it is determined that the imaging unit is at rest in the step of determining; and a step of recording an image data thus obtained, responcing a change in the image data thus sequentially obtained is detected in the step of detecting.

In addition, in order to achieve the above object, a computer readable storage medium records a program for an image processing apparatus having an imaging unit, the program *enabling a computer to realize the functions of: sequentially obtaining image data captured by the imaging unit; determining whether the imaging unit is at rest; detecting a change in image data sequentially obtained, in a state in which the function of determining determined that the imaging unit is at rest; and recording an image data thus obtained, responcing a change in the image data thus sequentially obtained is detected by the function of detecting.

### BRIEF DESCRIPTION OF THE DRAWINGS

FIG. 1A is a plan view showing an exterior configuration of an image processing apparatus according to an embodiment of the present invention, when an imaging side and a display side are respectively arranged on front and back sides;

FIG. 1B is a plan view showing an exterior configuration of the image processing apparatus according to the embodiment of the present invention, when the imaging side and the display side are arranged on the same side;

FIG. 2 is a perspective view in a case in which the image processing apparatus according to the embodiment of the present invention is set standing on a desk or the like;

FIG. 3 is a block diagram showing a hardware configuration of the image processing apparatus according to the first embodiment;

FIG. 4 is a functional block diagram showing a functional configuration for executing processing of recording at rest in the image processing apparatus according to the first embodiment;

FIG. 5A is a schematic diagram illustrating processing in an at-rest-state determination unit and showing an example of blocks BL set in an image of a single frame FR;

FIG. 5B is a diagram showing an example of each motion vector (arrows in the figure) detected in each block BL in FIG. 5A;

FIG. 6 is a histogram showing an example of a frequency distribution of motion vectors;

FIG. 7 is a flowchart illustrating a flow of processing of recording at rest according to the first embodiment;

FIG. 8 is a flowchart explaining a flow of at-rest-state determination processing;

FIG. 9 is a flowchart illustrating a flow of processing of detecting a change in an image;

FIG. 10 is a block diagram showing a hardware configuration of the image processing apparatus according to the second embodiment; and

FIG. 11 is a flowchart illustrating a flow of at-rest-state determination processing according to the second embodiment.

### DETAILED DESCRIPTION OF THE INVENTION

In the following, an embodiment of the present invention will be explained with reference to the drawings.

### First Embodiment

An image processing apparatus according to the present embodiment is configured by a digital camera, for example, and detects a change in image data sequentially obtained by capturing an object sequentially for image recognition of detecting entry of a new object into a frame.

Then, it has a function. of recording an object by controlling an operation of recording image data automatically, based on a change in image data thus sequentially obtained (hereinafter, referred to as “automatic recording function”).

Furthermore, in a case of performing imaging by means of an automatic imaging function, the image processing apparatus determines whether the image processing apparatus (more specifically, an imaging unit) is at rest, and in a case of determining that the image processing apparatus is at rest, activates recording of image data by means of the automatic recording function.

This can prevent it from being determined that there is a change in image data, caused by the image processing apparatus not being at rest, despite there not being entry of a new object into the frame, and the automatic recording function being executed.

In this way, the image processing apparatus according to the present embodiment can determine timing to execute the automatic recording function based on whether or not the image processing apparatus is at rest, and then can execute a processing sequence from detecting a change in image data until recording data of an image obtained by the automatic recording function (hereinafter, referred to as “captured image”).

### Configuration of Image Processing Apparatus

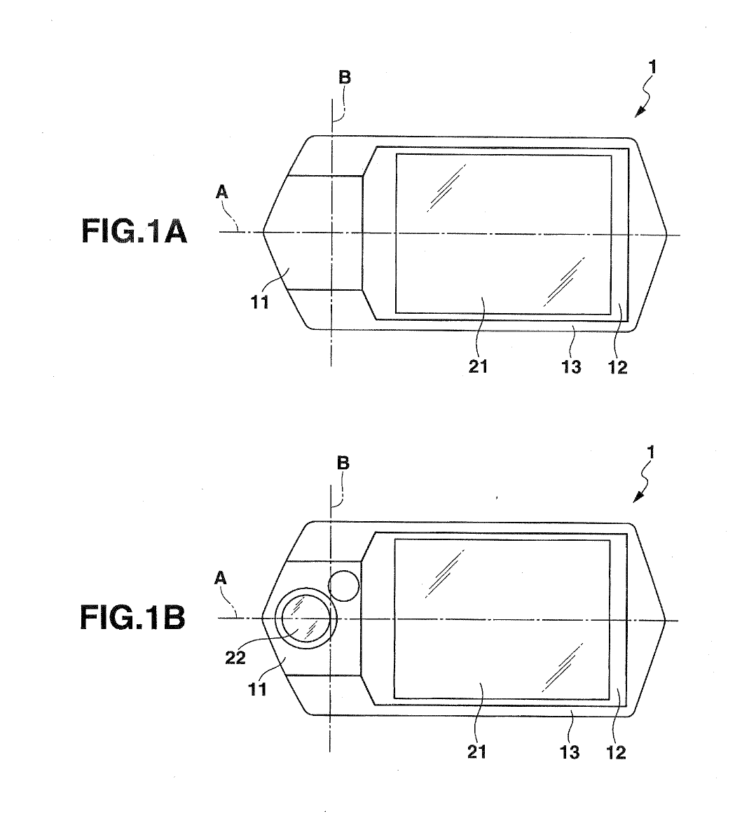

FIGS. 1A and 1B are plan views showing an exterior configuration of an image processing apparatus 1 according to an embodiment of the present invention.

In these figures, the image processing apparatus 1 includes a camera main body 11, a display unit main body 12, and a frame main body 13, each of which are connected to be movable with respect to each other.

It should be noted that FIG. 1A is a plan view when an imaging side of the camera main body 11 on which an imaging lens is disposed, and a display side of the display unit main body 12 on which a display is disposed are respectively arranged on front and, back sides of the image processing apparatus 1.

On the other hand, FIG. 1B is a plan view when the imaging side and the display side are provided on the same side of the image processing apparatus 1.

The camera main body 11 is formed in a short columnar shape with a pentagonal horizontal cross-section, the back side of the camera main body 11 is formed to be level, as shown in FIG. 1A.

Furthermore, as shown in FIG. 1B, an imaging side of an imaging unit 22 that captures an object image and outputs image data (face on the imaging lens side) is provided on a surface of the camera main body 11. In other words, the camera main body 11 constitutes a first housing that includes the imaging unit 22 therein.

The camera main body 11 is pivotally supported with respect to the display unit main body 12 so as to be able to rotate about a rotation axis A extending through the camera main body 11 and the display unit main body 12.

Furthermore, the camera main body 11 is pivotally supported with respect to the frame main body 13 so as to be able to rotate about a rotation axis B that is arranged to be orthogonal to the rotation axis A and extends through the camera main body 11 and the frame main body 13.

More specifically, the camera main body 11 is configured to be able to rotate about the rotation axis A, with the display unit main body 12 slidingly contacting with a side of the pentagonal shape of the camera main body 11.

It should be noted that, hereinafter, among the two ends of the image processing apparatus 1 in the longitudinal direction, a “camera side” refers to the side of the image apparatus 1 on which the camera main body 11 is provided (the left side in FIGS. 1A and 1B) and a “display unit side” refers to the side on which the display unit main body 12 is provided (the right side in FIGS. 1A and 1B).

The display unit main body 12 is formed in a substantially rectangular shape in a horizontal cross-section, and a rectangular display surface of a display unit 21 is positioned at the center of the surface of the display unit main body 12. In other words, the display unit main body 12 is a second housing that includes the display unit 21 therein.

The frame main body 13 is a frame member that is integrally formed as a component that configures two long sides in the longitudinal direction and one short side at a display unit side in the outer periphery of the image processing apparatus 1.

Furthermore, a short side of the frame main body 13 on a camera side of the image processing apparatus 1 is open, and this open portion holds the camera main body 11.

A portion of the short side of the frame main body 13 positioned at the display unit side is formed in a V-shape in which a face of the inner periphery side thereof follows the profile of the display unit main body 12 and a face of the outer periphery side thereof protrudes outward of the image processing apparatus 1.

The frame main body 13 is connected to the camera main body 11, i.e. the first housing, so as to be able to rotate about the rotation axis B.

In other words, the abovementioned rotation axis B extends through the portion at which the frame main body 13 holds the camera main body 11, and the frame main body 13 supports the camera main body 11 so that the camera main body 11 can swing about the rotation axis B to a front side and a back side within a space surrounded by the frame main body 13.

Thus, since the camera main body 11 is pivotally supported to the frame main body 13 to be rotatable about the rotation. axis B, the orientation of the surface on which imaging surface of the imaging unit 22 is disposed can be freely changed.

This means that, by rotating the camera main body 11, a user can direct the imaging surface of the imaging unit 22 to a far side into the drawing relative to the plane on which the imaging apparatus 1 is illustrated, as shown in FIG. 1A, and can direct the imaging surface of the imaging unit 22 to a near side out of the drawing, as shown in FIG. 1B.

Consequently, if the subject is present on this far side, the user can have the imaging unit 22 capture an image of the subject at this far side, by rotating the camera main body 11 about the rotation axis B to enter the state shown in FIG. 1A.

On the other hand, if the subject is present on the near side such as in a case of the user photographing himself/herself as the subject, the user can have the imaging unit 22 capture an image of the subject on the near side, by rotating the camera. main body 11 about the rotation axis B to enter the state shown in FIG. 1B.

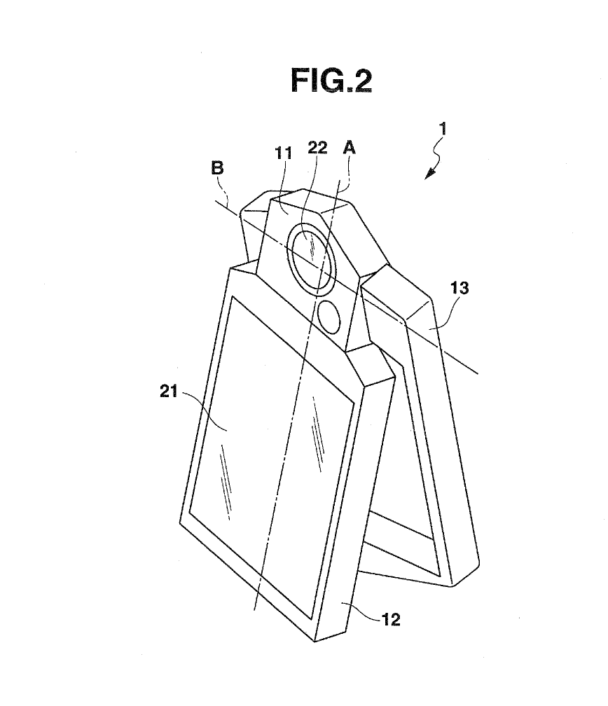

FIG. 2 is a perspective view showing the exterior configuration of the image processing apparatus 1 set standing on a desk or the like.

For example, when the user photographs himself/herself, the user first sets the image processing apparatus 1 to stand on a desk or the like, in a state in which normal lines to the display surface of the display unit 21 and to the imaging surface of the imaging unit 22 are each substantially the same direction to each other, and the camera main body 11 and the frame main body 13 have been rearranged so as to form a predetermined angle relative to each other about the rotation axis B, as shown in FIG. 2.

This means that the leading end of the V-shaped base constituting the frame main body 13 and the edge of the display unit main body 12 function as a pedestal by abutting with the surface of a desk or the like, and both the frame main body 13 and the display unit main body 12 are pivotally supported to each other via the rotation axis B to maintain a posture, whereby the image processing apparatus 1 can be set to stand on the desk or the like.

When the image processing apparatus 1 is set to stand as in FIG. 2, the image processing apparatus 1 may shake for a certain initial period of time and thus blur may arise in a captured image.

In this case, since there is concern over it being judged that there is a change in image data despite there not being entry of a new object into the frame, determination of the timing for imaging by means of the automatic recording function may not be performed properly.

To address this, an image processing apparatus 1 according to the present invention judges whether the image processing apparatus 1 remains at rest and, if the image processing apparatus 1 is in the state of remaining at rest (i.e. in a state in which an automatic recording function is to be executed), executes processing of imaging by means of an automatic imaging function (processing of recording at rest, as described later), a result of which it is possible to control imaging executed using image recognition more properly.

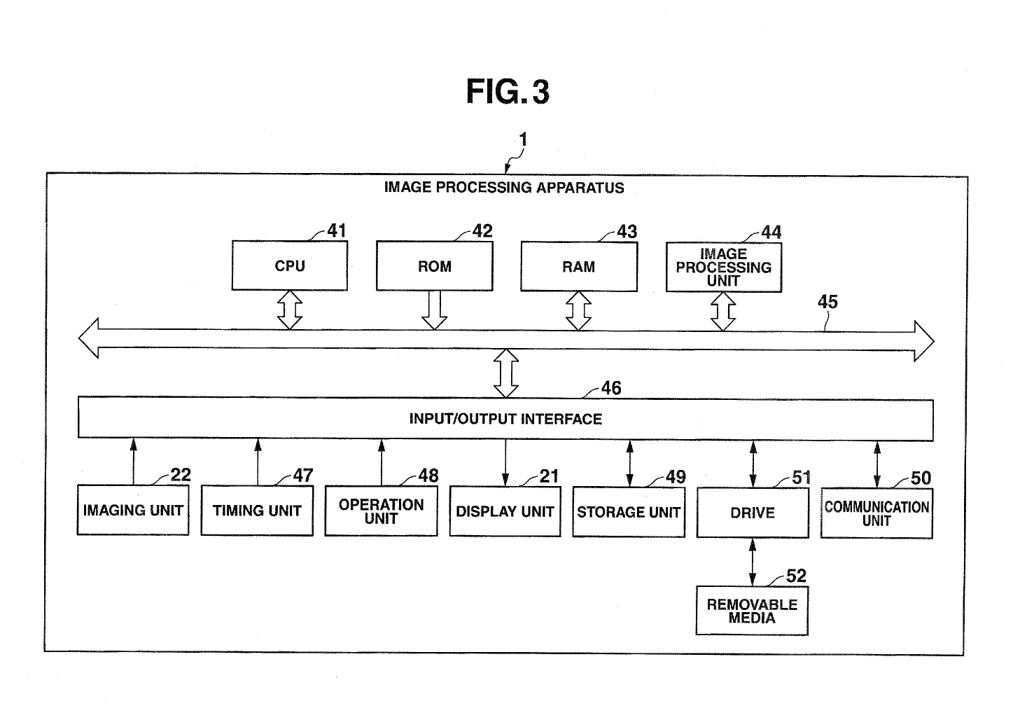

FIG. 3 is a block diagram showing the hardware configuration of the image processing apparatus 1 having an automatic recording function.

In addition to the display unit 21 and the imaging unit 22 as described above, the image processing apparatus 1 is further provided with a CPU (Central Processing Unit) 41, ROM (Read Only Memory) 42, RAM (Random Access Memory) 43, an image processing unit 44, a bus 45, an input/output interface 46, a timing unit 47, an operation unit 48, a storage unit 49, a communication unit 50, and a drive 51.

The CPU 41 executes various types of processing according to programs that are recorded in the ROM 42 or programs that are loaded from the storage unit 49 to the RAM 43,

The RAM 43 also stores data and the like necessary for the CPU 41 to execute the various processes, as appropriate.

The image processing unit 44 is configured by a DSP (Digital Signal Processor), VRAM (Video Random Access Memory), and the like, and cooperates with the CPU 41 to execute various kinds of image processing on image data.

For example, the image processing unit 44 executes image processing such as noise reduction, white balance adjustment, blur correction on the data of a captured image outputted from the imaging unit 22.

The CPU 41, the ROM 42, the RAM 43, and the image processing unit 44 are connected to one another via the bus 45. The bus 45 is also connected with the input/output interface 46. The input/output interface 46 is connected to the display unit 21, the imaging unit 22, the timing unit 47, the operation unit 48, the storage unit 49, the communication unit 50, and the drive 51.

The display unit 21 is configured by a display and the like capable of displaying various images.

The imaging unit 22 is provided with an optical lens unit and an image sensor, which are not illustrated.

In order to photograph a subject, the optical lens unit is configured by a light condensing lens such as a focus lens, a zoom lens and the like.

The focus lens is a lens for forming an image of a subject on the light receiving surface of the image sensor. The zoom lens is a lens for freely changing a focal length within a predetermined range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device.

The optoelectronic conversion device optoelectronically converts (i.e. captures) the image of the subject, accumulates the resultant image signal for a predetermined time interval, and sequentially supplies the image signal as an analog signal to the AFE.

The AFE executes various kinds of signal processing such as A/D (Analog/Digital) conversion processing of the analog image signal. The various kinds of signal processing generate a digital signal, which is output as an output signal from the imaging unit 22.

Such an output signal from the imaging unit 22 is data of a captured image, and is provided as appropriate to the CPU 41, the image processing unit 44, and the like.

The timing unit 47 executes time measurement under the control of the CPU 41.

The operation unit 48 is configured by various buttons such as a shutter button (not illustrated), and accepts instruction operations from a user.

The storage unit 49 is configured by DRAM (Dynamic Random Access Memory) or the like, and stores data of various images.

The communication unit 50 controls communication with other devices via a network, which includes the Internet.

Removable media 52 made from a magnetic disk, an optical disk, a magneto-optical disk, semiconductor memory, or the like is installed in the drive 51, as appropriate.

Programs read via the drive 51 from the removable media 52 are installed in the storage unit 49 as necessary.

In addition, similarly to the storage unit 49, the removable media 52 can also store various kinds of data such as the image data stored in the storage unit 49.

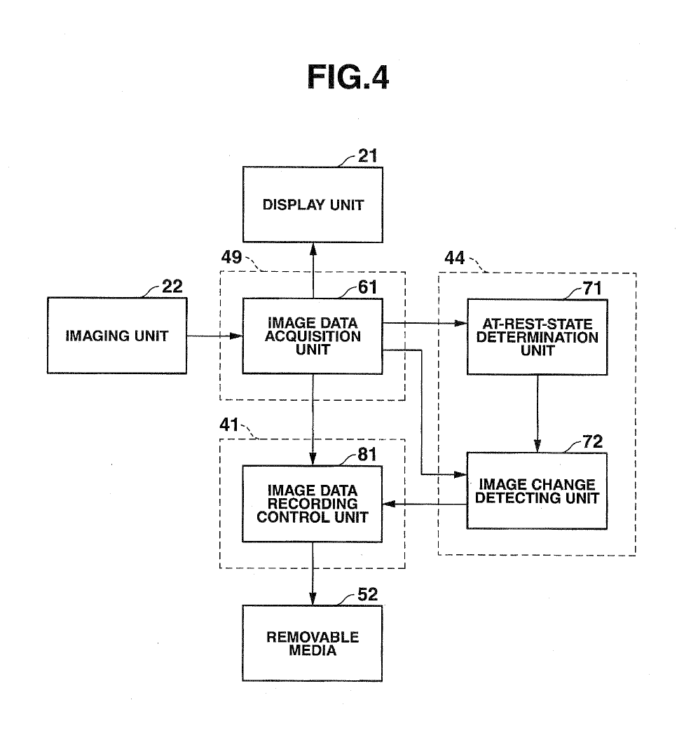

FIG. 4 is a functional block diagram showing a functional configuration for executing processing of recording at rest in the image processing apparatus 1.

The processing of recording at rest refers to a sequence of processing including determining whether the image processing apparatus 1 is at rest and, in a case of determining as being at rest, detecting the change in image data sequentially obtained to perform imaging by means of the automatic recording function.

An image data acquisition unit 61 includes a frame buffer, and obtains image data sequentially outputted from the imaging unit 22 and stores the obtained image data separated into predetermined frames.

More specifically, the image data acquisition unit 61 stores the image data outputted from the imaging unit 22 separated into at least two frames.

Then, with the image data stored by the image data acquisition unit 61 set as a detection target, an at-rest-state determination unit 71 performs detection of motion vectors in order to determine whether the image processing apparatus 1 is at rest, and an image change detecting unit 72 performs detection of a change between the frames (change in image data sequentially obtained) in order to perform an automatic recording.

Furthermore, image data of the latest frame stored in the image data acquisition unit 61 is displayed sequentially on the display unit 21.

The at-rest-state determination unit 71 detects motion vectors for each block that is set in advance in the image data of a single frame stored in the image data acquisition unit 61.

At this moment, the block defining a unit for detecting a motion vector can be a macro block used for encoding and decoding a moving image or can be a block of any size that is made by assembling a plurality of macro blocks.

Then, the at-rest-state determination unit 71 determines whether the image processing apparatus 1 is at rest or not based on a frequency distribution of the motion vectors thus detected.

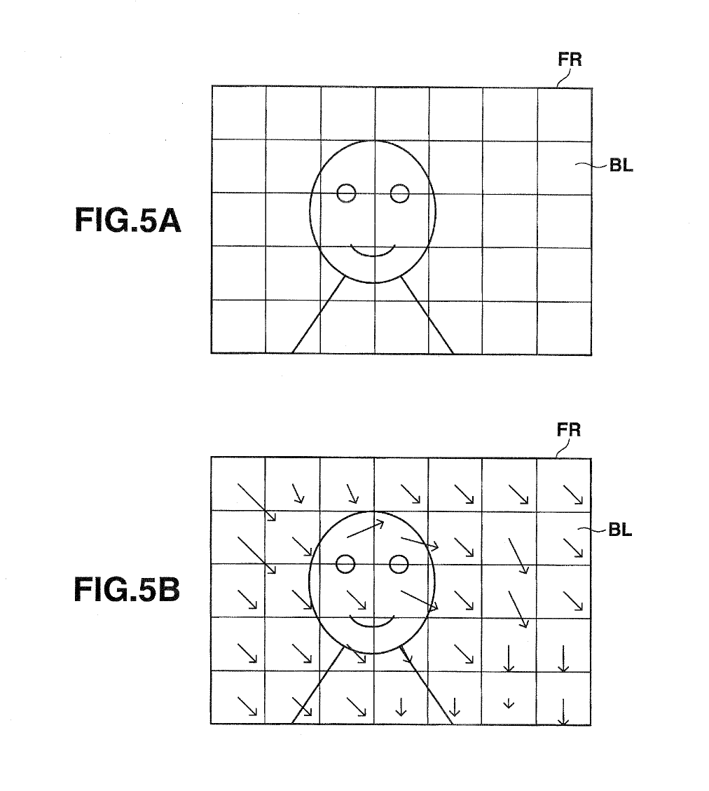

Both FIGS. 5A and 5B are schematic diagrams illustrating processing in the at-rest-state determination unit 71.

FIG. 5A is a diagram showing an example of blocks BL set in an image of a single frame FR.

FIG. 5B is a diagram showing an example of each motion vector (arrows therein) included in each block BL in FIG. 5A.

The at-rest-state determination unit 71 obtains a frequency distribution that associates a type of a motion vector with a frequency thereof in each block BL set as in FIG. 5A.

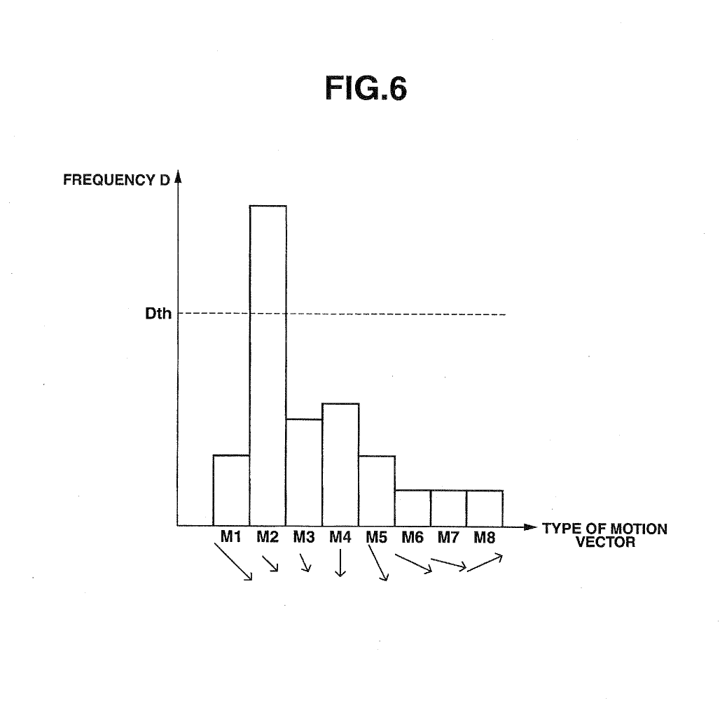

FIG. 6 is a histogram showing an example of a frequency distribution of the motion vectors shown in FIG. 5B.

In the histogram shown in FIG. 6, a frequency is counted for each type of the motion vector M1 to M8.

The at-rest-state determination unit 71 obtains a frequency distribution in this manner, compares a threshold Dth that is set for a frequency of a motion vector with a frequency D of each motion vector, and, in a case in which the frequency D of any of the motion vectors exceeds the threshold Dth, determines that the image processing apparatus 1 is shaking and is not at rest (blur occurring in image, and thus a decision of timing for imaging by means of an automatic recording function is not performed properly).

This is because when similar motion vectors are obtained in each block, the entire image is assumed to move in a similar manner for the reason that the image processing apparatus 1 is shaking or the like.

It should be noted that it is possible to count the frequency by recognizing motion vectors having a direction and length that falls into a range set in advance as motion vectors of the same type as well as counting the frequency by recognizing motion vectors having an identical direction and length as motion vectors of the same type.

When the at-rest-state determination unit 71 determines that the image processing apparatus 1 is not shaking and is at rest (blur not occurring in image), it outputs a signal indicating that the image processing apparatus 1 is at rest (hereinafter, referred to as “at-rest signal”) to the image change detecting unit 72.

The image change detecting unit 72 detects changes in image data of a plurality of frames stored in the image data acquisition unit 61.

More specifically, the image change detecting unit 72 calculates the correlation between image data of a preceding frame and image data of a subsequent frame and, in a case of the correlation falling below a threshold, determines that a change occurs in the image data of these frames.

In other words, when the correlation of image data lowers, such as when a new object enters a frame between the image data of sequential frames, a change in the image data is detected by the image change detecting unit 72.

In the image processing apparatus 1 according to the present embodiment, such changes in the image data are set as a trigger for a shutter signal (instruction signal for imaging) by means of the automatic recording function, and when a change in the image data is detected, the image change detecting unit 72 outputs, to an image data recording control unit 81, a shutter signal to have removable media 52 store the image data displayed on the display unit 21 therein.

When a shutter signal is inputted from the image change detecting unit 72, the image data recording control unit 81 obtains image data of a latest frame stored in the image data acquisition unit 61 and records the image data in the removable media 52 as data of a captured image.

### Operations

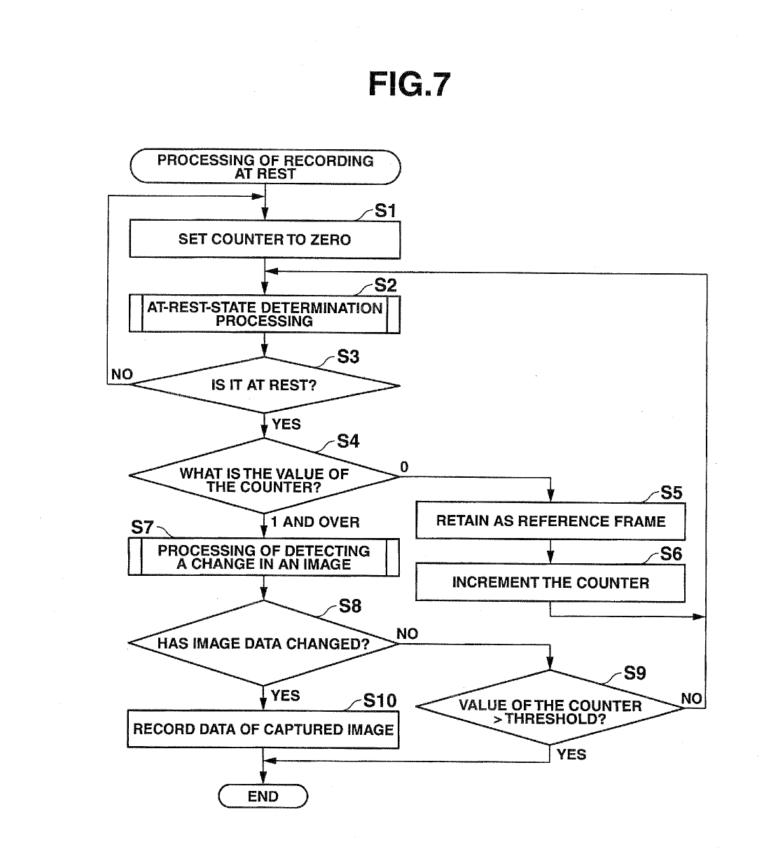

Next, processing of recording at rest executed by the image processing apparatus 1 having the functional configuration in FIG. 4 will be explained with reference to FIG. 7. FIG. 7 is a flowchart illustrating a flow of processing of recording at rest. In the present embodiment, the processing of recording at rest is started when a user performs, on the operation unit 48, an operation to instruct execution of the processing of recording at rest.

In FIG. 7, when the processing of recording at rest is started, the at-rest-state determination unit 71 sets a counter for an at-rest-state determination to be zero (i.e. initializes) in Step S1.

In Step S2, the at-rest-state determination unit 71 executes processing of at-rest-state determination (described later) and obtains a determination result of whether or not the image processing apparatus 1 is at rest.

In Step S3, the at-rest-state determination unit 71 determines whether the determination result in Step S2 indicates that the image processing apparatus 1 is at rest.

In a case in which the determination result in Step S2 does not indicate that the image processing apparatus 1 is at rest, it is determined as NO in Step S3, and the processing returns to Step S1.

On the other hand, in a case in which the determination result in Step S2 indicates being a state in which the image processing apparatus 1 is at rest, it is determined as YES in Step S3, and the processing advances to Step S4.

In Step S4, the at-rest-state determination unit 71 determines the value of the counter.

In a case in which the value of the counter is zero, the processing advances to Step S5 after the determination in Step S4.

In Step S5, the at-rest-state determination unit 71 retains image data of a latest frame stored in the image data acquisition unit 61 as a reference for detecting a change in an image at the image change detecting unit 72 (hereinafter, referred to as “reference frame”).

In Step S6, the at-rest-state determination unit 71 increments the value of the counter for at-rest-state determination.

After Step S6, the processing returns to Step S2.

In a case in which the value of the counter is no less than 1, the processing advances to Step S7 after the determination in Step S4.

At this moment, an at-rest signal is outputted from the at-rest-state determination unit 71 to the image change detecting unit 72, whereby the image change detecting unit 72 is instructed to execute the processing.

In Step S7, the image change detecting unit 72 executes processing of detecting a change in an image (described later), and obtains a determination result as to whether image data has changed due to, for example, a new object entering the frame.

In Step S8, the image change detecting unit 72 determines whether the determination result of whether the image data has changed indicates that the image data has changed.

In a case in which the determination result of whether the image data has changed does not indicate that the image data has changed, it is determined as NO in Step S8, and the processing advances to Step S9.

In Step S9, the image change detecting unit 72 determines whether the value of the counter is greater than a threshold set for time out. In this way, in Step S9, the counter for an at-rest-state determination is employed for a time out determination.

In a case in which the value of the counter is not more than the threshold set for the time out, it is determined as NO in Step S9, and the processing returns to Step S2.

On the other hand, in a case in which the value of the counter is greater than the threshold. set for the time out, it is determined as YES in Step S9, and the processing of recording at rest ends.

Furthermore, in a case in which the determination result of whether the image data has changed indicates that the image data has changed, it is determined as YES in Step S8, and the processing advances to Step S10.

At this moment, a shutter signal is outputted from the image change detecting unit 72 to the image data recording control unit 81, whereby execution of processing is instructed to the image data recording control unit 81.

In Step S10, the image data recording control unit 81 obtains image data of a latest frame stored in the image data acquisition unit 61 as data of a captured image, and stores it in the removable media 52.

When the processing of Step S10 ends, the processing of recording at rest ends.

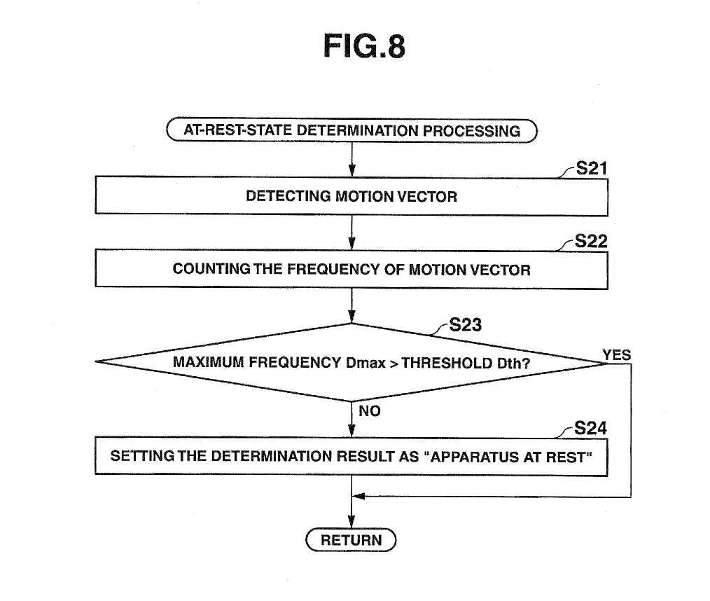

Next, at-rest-state determination processing executed by the image processing apparatus 1 with the functional configuration of FIG. 4 as a sub flow of the at-rest recording processing will be explained with reference to FIG. 8.

FIG. 8 is a flowchart illustrating the flow of the at-rest-state determination processing.

The at-rest-state determination processing is launched as a sub flow in Step S2 of the processing of recording at-rest.

In Step S21, the at-rest-state determination unit 71 detects a motion vector for each block that is set in advance in the image data of a single frame stored in the image data acquisition unit 61.

In Step S22, the at-rest-state determination unit 71 counts the frequency for each type of motion vector thus detected, of the single frame.

In Step S23, the at-rest-state determination unit 71 determines whether a maximum frequency Dmax of a motion vector is greater than a threshold Dth set for the frequency of the motion vector.

In a case in which the maximum frequency Dmax of the motion vector is greater than the threshold Dth, it is determined as YES in Step S23, and the processing returns to the processing of recording at rest. In other words, when many similar motion vectors are obtained, it can be assumed that the entire image undergoes the same movement (the image processing apparatus 1 is not at rest). Therefore, the determination result in which the image processing apparatus 1 is at rest is not set, and the processing returns to the processing of recording at rest.

On the other hand, in a case in which the maximum frequency Dmax of the motion vector is not more than the threshold. Dth, it is determined as NO in Step S23, and the processing advances to Step S24.

In Step S24, the at-rest-state determination unit 71 sets the determination result in which the image processing apparatus 1 is at rest.

When the processing of Step S24 ends, the processing returns to the processing of recording at rest.

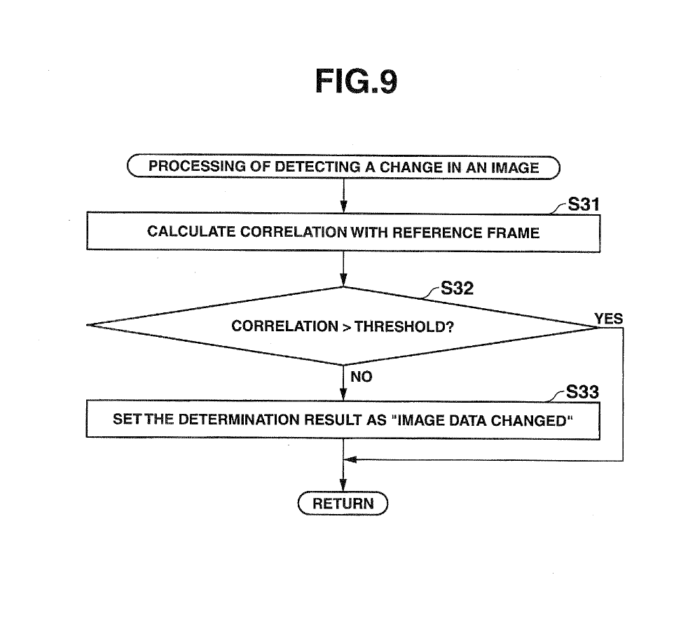

Next, processing of detecting a change in an image executed by the image processing apparatus 1 with the functional configuration of FIG. 4 as a sub flow of the at-rest recording processing will be explained with reference to FIG. 9.

FIG. 9 is a flowchart illustrating a flow of processing of detecting a change in an image.

The processing of detecting a change in an image is launched as sub flow in Step S7 of the processing of recording at rest.

In Step S31, the image change detecting unit 72 calculates the correlation between image data of a reference frame and the image data of a frame newly stored.

At this moment, the image change detecting unit 72 calculates the correlation, for example, for each block set in an image or for each frame arbitrarily set for evaluating the correlation.

In Step S32, the image change detecting unit 72 determines whether the correlation calculated in Step S31 is greater than a threshold set for the correlation.

In a case in which the correlation calculated in Step S31 is greater than the threshold, it is determined as YES in Step S32, and the processing returns to the processing of recording at rest.

In other words, when the correlation between the image data of the reference frame and the image data newly stored is greater than the threshold, it is assumed that there is no change from the image data of the reference frame (there is no change in an object); therefore, the determination result in which the image data has changed is not set, and the processing returns to the processing of recording at rest.

On the other hand, in a case in which the correlation calculated in Step S31 is not more than the threshold, it is determined as NO in Step S32, and the processing advances to Step S33.

In Step S33, the image change detecting unit 72 sets the determination result in which the image data has changed.

When the processing of Step S33 ends, the processing returns to the processing of recording at rest.

As described above, the image processing apparatus 1 of the first embodiment includes the at-rest-state determination unit 71 that determines whether the image processing apparatus 1 is at rest or not based on the motion vectors of the image data, and the image change detecting unit 72 that detects a change in image data that are sequentially inputted.

Then, in a case in which it is determined by the at-rest-state determination unit 71 that the image processing apparatus 1 is at rest, the image change detecting unit 72 detects the change in the image data, and in a case in which the image data has changed, records the data of the captured image.

Therefore, in a state in which the image processing apparatus is at rest and thus it is suitable to determine the timing for imaging by means of the automatic recording function, it is possible to perform image recognition for recording image data by means of the automatic recording function.

Therefore, since changes in the image data can be determined more properly, the control of recording of image data performed. using image recognition can be improved.

Furthermore, since the at-rest-state determination unit 71 repetitively determines that the image processing apparatus 1 is at rest in the processing of recording at rest, immediately after the image processing apparatus 1 comes to rest, recording of the image data by means of the automatic recording function becomes possible.

Therefore, even in a case in which a user is holding the image processing apparatus 1 by hand, it is possible to acquire a period of time in which imaging is possible for longer.

Furthermore, since the at-rest-state determination unit 71 determines whether the image processing apparatus 1 is at rest based on a motion vector for each block in the image data, whether or not the image processing apparatus 1 is at rest is determined based on a state of an image that directly affects image recognition.

Therefore, the timing for determining image data to be recorded by the automatic recording function can be improved.

Furthermore, the image change detecting unit 72 detects the change in the image data of sequential frames, and sets the change as a trigger for the shutter signal.

Therefore, it is possible to successfully perform photographing without missing an instant photographing opportunity such as timing in which an object newly positions with in a frame.

Furthermore, after the at-rest-state determination unit 71 determines that the image processing apparatus 1 is at rest, the image change detecting unit 72 determines whether it is timed out by referring to the value of the counter.

Therefore, it is possible to prevent a state of standing by for photographing from continuing for a long time in a case in which no change in image data has been detected for a certain period of time after the image processing apparatus 1 comes to rest.

### Application Examples

Although the threshold Dth is set to a fixed value in Step S23 of the at-rest-state determination processing in the first embodiment, the threshold Dth can be variable.

For example, the threshold Dth can be calculated in accordance with the frequency distribution. of the motion vectors in each image data set, and the threshold Dth thus calculated can be used in the determination of Step S23 for this image data set.

In this case, it is possible to lower the threshold Dth as variation in the frequency of motion vectors increases, as well as to raise the threshold Dth as the variation in the frequency of motion vectors decreases.

In this way, it is possible to determine whether the image processing apparatus 1 is at rest more properly in accordance with contents of image data (i.e. a state of an object).

### Second Embodiment

In the first embodiment, the at-rest-state determination processing detects motion vectors in image data and determines whether the image processing apparatus 1 is at rest based on the frequency distribution thereof.

On the other hand, in the second embodiment, the image processing apparatus 1 additionally includes an acceleration sensor, and determines whether the image processing apparatus 1 is at rest based on a detection signal of the acceleration sensor.

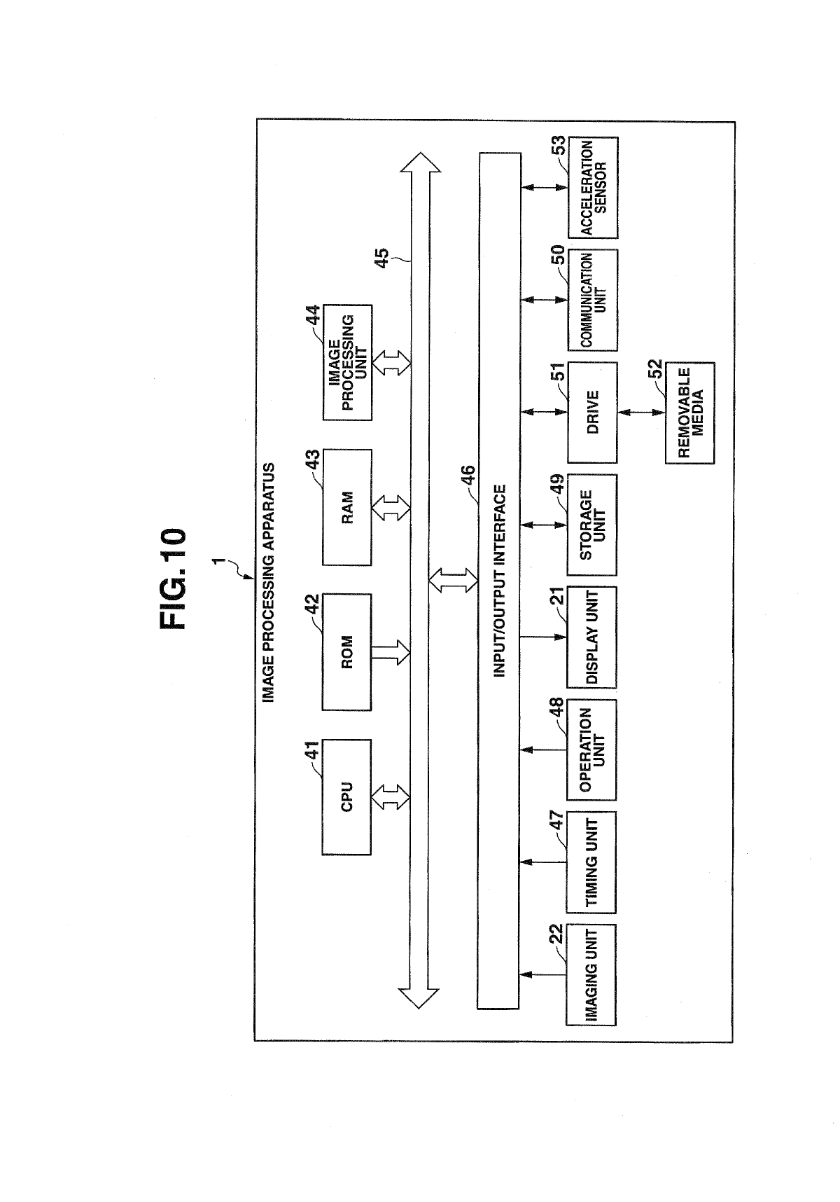

FIG. 10 is a block diagram showing the hardware configuration of the image processing apparatus 1 according to the second embodiment.

The image processing apparatus 1 is provided with the display unit 21, the imaging unit 22 the CPU (Central Processing Unit) 41, the ROM (Read Only Memory) 42, the RAM (Random Access Memory) 43, the image processing unit 44, the bus 45, the input/output interface 46, the timing unit 47, the operation unit 48, the storage unit 49, the communication unit 50, the drive 51, and an acceleration sensor 53.

Among these, each component other than the acceleration sensor 53 is similar to that in the first embodiment.

The acceleration sensor 53 is an acceleration sensor of piezoresistance type, capacitance detection type, or the like, and detects an acceleration acting on the image processing apparatus 1.

Then, the acceleration sensor 53 outputs a signal indicating an acceleration thus detected to the CPU 41 and the image processing apparatus 44 via the bus 45.

In the hardware configuration shown in FIG. 10, its functional configuration for performing processing of recording at rest is similar to the configuration of FIG. 4 except for the function of the at-rest-state determination unit 71.

The at-rest-state determination unit 71 obtains a signal indicating an acceleration outputted from the acceleration sensor 53, and, if the acceleration exceeds the threshold set for the acceleration, determines that the image processing apparatus 1 is shaking, and is not at rest.

### Operations

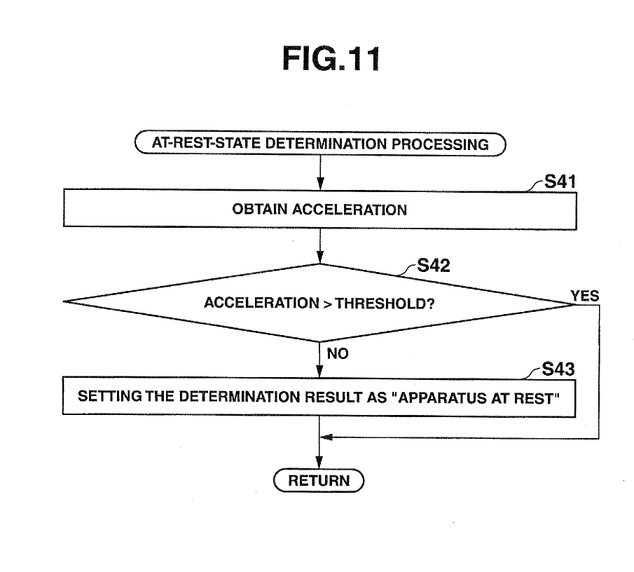

Next, at-rest-state determination processing according to the second embodiment will be explained with reference to FIG. 11.

FIG. 11 is a flowchart explaining a flow of the at-rest-state determination processing according to the second embodiment.

The at-rest-state determination processing is launched as a sub flow in Step S2 of the processing of recording at-rest.

In Step S41, the at-rest-state determination unit 71 obtains a signal indicating an acceleration inputted from the acceleration sensor 53.

In Step S42, the at-rest-state determination unit. 71 determines whether the acceleration indicated by the signal obtained in Step S41 is greater than a threshold set for the acceleration.

In a case in which the acceleration indicated by the signal obtained in Step S41 is greater than the threshold set for the acceleration, it is determined as YES in Step S42, and the processing returns to the processing of recording at rest.

In other words, a determination result in which the image processing apparatus 1 is at rest is not set and the processing returns to the processing of recording at rest.

On the other hand, in a case in which the acceleration indicated by the signal obtained in Step S41 is not more than the threshold set for the acceleration, the processing advances to Step S43.

In Step S43, the at-rest-state determination unit 71 sets the determination result indicating that the image processing apparatus 1 is at rest.

When the processing of Step S43 ends, the processing returns to the processing of recording at rest.

As described above, the image processing apparatus 1 of the second embodiment includes the at-rest-state determination unit 71 that determines whether the image processing apparatus 1 is at rest or not based on the acceleration detected by the acceleration sensor 53, and the image change detecting unit 72 that detects the change in image data that are sequentially inputted.

Then, in a case in which it is determined by the at-rest-state determination unit 71 that the image processing apparatus 1 is at rest, the image change detecting unit 72 detects the change in the image data, and in a case in which the image data has changed, records the data of the captured image.

Therefore, in a state in which the image processing apparatus is at rest and thus it is suitable to determine timing for recording image data by means of the automatic recording function, it is possible to perform image recognition for recording by means of the automatic recording function.

Therefore, since changes in the image data can be determined more properly, the control of recording of image data performed using image recognition can be improved.

Furthermore, the at-rest-state determination unit 71 determines whether the image processing apparatus 1 is at rest based on the acceleration detected by the acceleration sensor 53 included by the image processing apparatus 1; therefore, whether or not the image processing apparatus 1 is at rest is determined based on the acceleration caused by shaking actually occurring in the image processing apparatus 1.

Therefore, the resting state of the image processing apparatus 1 can be determined more properly, and the control of the timing for recording of image data by means of the automatic recording function can be improved.

It should be noted that the present invention is not limited to the abovementioned embodiments, and that modifications, improvements, etc. within a scope that can achieve the object of the present invention shall be considered to be included in the present invention.

For example, although an example in which a digital camera including the imaging unit 22 is provided as the image processing apparatus 1 in the abovementioned embodiments, the present invention can also be applied to an apparatus to which image data of an image captured by an imaging unit of another apparatus is inputted, without having its own imaging unit 22, (e.g., an information processing apparatus that sequentially receives image data of an image captured by a web camera of the other party).

Alternatively, the present invention can also be applied to an apparatus in which the imaging unit 22 is established as a unit that can be separated from the image processing apparatus 1.

In this case, the effects of the present invention are exerted by detecting motion vectors or detecting an acceleration by means of the acceleration sensor in the at-rest-state determination processing so as to determine whether an imaging unit (more specifically, an apparatus or a unit having an imaging unit) is at rest.

Although the removable media 52 is used as storage media in the abovementioned embodiments, the present invention is not limited thereto.

For example, a storage unit (e.g., hardware) in another apparatus (e.g., a server) on the network may be used.

Furthermore, although the image processing apparatus to which the present invention is applied has been explained in the aforementioned embodiments as an example of a digital camera, the present invention is not particularly limited thereto.

For example, the image processing apparatus according to the present invention can generally be applied to any electronic device having an image processing function.

More specifically, the image processing apparatus according to the present invention can be applied to a laptop personal computer, a video camera, a portable navigation device, a cell phone device, a portable game device, and the like.

The processing sequence described above can be executed by hardware, and also can be executed by software.

In other words, the hardware configuration shown in FIG. 4 is merely an illustrative example, and the present invention is not particularly limited thereto.

More specifically, the types of functional blocks employed to realize the above-described functions are not particularly limited to the example of FIG. 4, so long as the image processing apparatus can be provided with the functions enabling the aforementioned processing sequence to be executed in its entirety.

A single functional block may be configured by a single piece of hardware, a single installation of software, or any combination thereof.

In a case in which the processing sequence is to be executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable media 52 shown in FIGS. 3 and 10 distributed separately from the device main body for supplying the program to a user, but also can be constituted by a storage medium or the like supplied to the user in a state incorporated in the device main body in advance.

The removable media 52 is composed of a magnetic disk (including a floppy disk), an optical disk, a magnetic optical disk, or the like, for example.

The optical disk is composed of a CD-ROM (Compact Disk-Read Only Memory), a DVD (Digital Versatile Disk), or the like, for example.

The magnetic optical disk is composed of an MD (Mini-Disk) or the like.

The storage medium supplied to the user in a state incorporated in the device main body in advance may include the ROM 42 shown in FIGS. 3 and 10, a hard disk (not shown)or the like included in the storage unit 49 in FIGS. 3 and 10 in which the program is recorded, for example.

It should be noted that, in the present specification, the steps describing the program recorded in the storage medium include not only the processing executed in a time series following this order, but also processing executed in parallel or individually, which is not necessarily executed in a time series.

Although some embodiments of the present invention are explained above, these embodiments are merely exemplifications, and do not limit the technical scope of the present invention.

The present invention can adopt various other embodiments, and further, various modifications such as omissions and substitutions can be made thereto within a scope that does not deviate from the gist of the present invention.

These embodiments and modifications thereof are included in the scope and gist of the invention described in the present disclosure, and are included in the invention described in the accompanying claims and the scope of equivalents thereof.

What is claimed is:

1. An image processing apparatus comprising:
an imaging unit;
an acquisition unit that sequentially obtains image data captured by the imaging unit;
a determination unit that determines whether the imaging unit is at rest;
a detecting unit that detects a change in the image data thus sequentially obtained, in a state in which the determination unit determined that the imaging unit is at rest; and
an image data recording unit that records an image data thus obtained, responcing a change in the image data thus sequentially obtained is detected by the detecting unit.

2. The image processing apparatus according to claim 1,
wherein the determination unit repetitively determines whether the imaging unit is at rest, and
wherein the detecting unit detects a change in the image data thus sequentially obtained, in a state in which the determination unit determined that the imaging unit is at rest.

3. The image processing apparatus according to claim 1, further comprising:
a motion vector detecting unit that divides the image data thus sequentially obtained into areas and detects a motion vector for each of the areas thus divided;
a frequency calculating unit that calculates a frequency of the motion vector detected by the motion vector detecting unit; and
a frequency determination unit that determines whether a maximum frequency, among the frequencies of the motion vectors calculated by the frequency calculating unit, is greater than a threshold set in advance for the frequency of the motion vector,
wherein the determination unit determines that the imaging unit is at rest in a case in which the frequency determination unit determines that the maximum frequency of motion vector is no more than the threshold set in advance.

4. The image processing apparatus according to claim 1, further comprising:
an acceleration detecting unit that detects acceleration; and
an acceleration determination unit that determines whether the acceleration detected by the acceleration detecting unit is greater than a threshold set in advance for the acceleration,
wherein the determination unit determines that the imaging unit is at rest in a case in which the acceleration determination unit determines that the acceleration is no more than the threshold set in advance.

5. The image processing apparatus according to claim 1, further comprising:
a correlation calculating unit that calculates a cross correlation of the image data thus sequentially obtained, in a case in which the determination unit determines that the imaging unit is at rest; and
a correlation determination unit that repetitively determines whether or not the correlation calculated by the correlation calculating unit is greater than a threshold set in advance for the correlation,
wherein the image data recording unit determines that a change in the image data thus sequentially obtained is detected and records the image data thus obtained, responcing the correlation determination unit makes a determination of NO.

6. The image processing apparatus according to claim 1, further comprising:
a counting unit that counts by incrementing a value of a number of times, in a case in which the determination unit determines that the imaging unit is at rest;
a value determination unit that determines whether the value counted by the counting unit is greater than a threshold set in advance for the value; and
an ending unit that ends the determination by the determination unit, in a case in which the value determination unit determines that the value thus counted is greater than the threshold set in advance for the value.

7. An image processing method for an image processing apparatus having an imaging unit, comprising:
a step of sequentially obtaining image data captured by the imaging unit;
a step of determining whether the imaging unit is at rest;
a step of detecting a change in the image data thus sequentially obtained, in a state in which it is determined that the imaging unit is at rest in the step of determining; and
a step of recording an image data thus obtained, responcing a change in the image data thus sequentially obtained is detected in the step of detecting.

8. A computer readable storage medium recording a program for an image processing apparatus having an imaging unit, the program enabling a computer to realize the functions of:
sequentially obtaining image data captured by the imaging unit;
determining whether the imaging unit is at rest;
detecting a change in image data sequentially obtained, in a state in which the function of determining determined that the imaging unit is at rest; and
recording an image data thus obtained, responcing a change in the image data thus sequentially obtained is detected by the function of detecting.
